(19) United States
(12) Patent Application Publication
(10) Pub. No.: US 2023/0058175 A1
(43) Pub. Date: Feb. 23, 2023

(54) SINGLE-CRYSTAL DIAMOND CUTTING TOOL

(71) Applicant: A.L.M.T. Corp., Tokyo (JP)

(72) Inventors: Hiroki YAMADA, Kato-Shi (JP); Makoto YUKAWA, Kato-shi (JP)

(73) Assignee: A.L.M.T. Corp., Tokyo (JP)

(21) Appl. No.: 17/793,375

(22) PCT Filed: Dec. 22, 2020
(86) PCT No.: PCT/JP2020/047858

§ 371 Date: Jul. 15, 2022

(30) Foreign Application Priority Data
Jan. 17, 2020 (JP) 2020-005599

(51) Int. Cl. B23B 27/20; B23B 27/00

(52) U.S. Cl. CPC B23B 27/20; B23B 27/005; B23B 2200/081; B23B 2200/242; B23B 2200/3609

(57) ABSTRACT

A single-crystal diamond cutting tool is provided with a flank and a rake face, a cutting edge being provided at a boundary between the flank and the rake face, an inclined surface being provided at a location distant from the cutting edge, the inclined surface being contiguous to the rake face and inclined at 0.05 degrees or more and 80 degrees or less with respect to the rake face, the rake face having a roughness Ra of 1 µm or less, the cutting edge being provided with a chamfered surface or round honing having a width of 1 µm or less, the cutting edge having projections and depressions having a width of 100 nm or less and smaller than that of the chamfered surface or round honing.

### TECHNICAL FIELD

The present disclosure relates to a single-crystal diamond cutting tool. This application claims priority based on Japanese Patent Application No. 2020-005599 filed on Jan. 17, 2020. The entire contents of the description in this Japanese patent application are incorporated herein by reference.

### BACKGROUND ART

Conventional single-crystal diamond cutting tools are disclosed in PTL 1 (Japanese Patent Laying-Open No. 2014 -012310) and PTL 2 (Japanese Patent Laying-Open No. 2006 -015412).

### Citation List

### Patent Literature

[PTL 1] Japanese Patent Laying-Open No. 2014-012310 [PTL 2] Japanese Patent Laying-Open No. 2006-015412

### SUMMARY OF INVENTION

A single-crystal diamond cutting tool according to an aspect of the present disclosure is a single-crystal diamond cutting tool provided with a flank and a rake face, a cutting edge being provided at a boundary between the flank and the rake face, an inclined surface being provided at a location distant from the cutting edge, the inclined surface being contiguous to the rake face and inclined at 0.05 degrees or more and 80 degrees or less with respect to the rake face, the rake face having a roughness Ra of 1 µm or less, the cutting edge being provided with a chamfered surface or round honing having a width of 1 µm or less, the cutting edge having projections and depressions having a width of 100 nm or less and smaller than that of the chamfered surface or round honing.

### BRIEF DESCRIPTION OF DRAWINGS

FIG. 1 is a plan view of a single-crystal diamond cutting tool 1 according to a first embodiment.

FIG. 2 is a side view of single-crystal diamond cutting tool 1 viewed in a direction indicated in FIG. 1 by an arrow II.

FIG. 3 is an enlarged plan view of a single-crystal diamond 3 of a portion surrounded by a circle III indicated in FIG. 1.

FIG. 4 is a cross section of single-crystal diamond 3 taken along a line IV-IV indicated in FIG. 3.

FIG. 5 is an enlarged plan view of single-crystal diamond 3 of a portion surrounded by a circle V indicated in FIG. 3.

FIG. 6 is a cross section of single-crystal diamond 3 taken along a line VI-VI indicated in FIG. 5.

FIG. 7 is an enlarged view of a portion surrounded by a circle VII indicated in FIG. 5 for showing projections and depressions 200a and 200b of a first cutting edge 20a and a second cutting edge 20b.

FIG. 8 is a diagram for illustrating a method of measuring a width L1 of a chamfered surface 20c.

FIG. 9 is a diagram for illustrating a method of measuring widths A1 and A2 of projections and depressions 20a and 20b of first cutting edge 20a and second cutting edge 20b.

FIG. 10 is a cross section of single-crystal diamond 3 according to a second embodiment corresponding to FIG. 6, and is a cross section showing round honing 20h provided to cutting edge 20.

FIG. 11 is an enlarged plan view of cutting edge 20 shown in FIG. 10.

FIG. 12 is a cross section of a single-crystal diamond cutting tool having a rake face 10 and a flank 11 contiguous to round honing 20h, as taken orthogonally to rake face 10 and flank 11, for illustrating a method of measuring a width L2 of round honing 20h.

FIG. 13 is a cross section of a single-crystal diamond cutting tool having curved surfaces 400 and 500 between round honing 20h and rake face 10 and flank 11, as taken orthogonally to rake face 10 and flank 11, for illustrating a method of measuring width L2 of round honing 20h.

### DESCRIPTION OF EMBODIMENTS

### Problem to Be Solved by the Present Disclosure

Conventional single-crystal diamond cutting tools are required to have further increased service life in high-accuracy cutting.

### Advantageous Effect of the Present Disclosure

According to the present disclosure, a single-crystal diamond cutting tool capable of cutting with high accuracy and having a long service life can be provided.

### Description of Embodiments of the Present Invention

Initially, embodiments of the present invention will be enumerated and described.

A single-crystal diamond cutting tool according to an aspect of the present disclosure is a single-crystal diamond cutting tool provided with a flank and a rake face, a cutting edge being provided at a boundary between the flank and the rake face, an inclined surface being provided at a location distant from the cutting edge, the inclined surface being contiguous to the rake face and inclined at 0.05 degrees or more and 80 degrees or less with respect to the rake face, the rake face having a roughness Ra of 1 µm or less, the cutting edge being provided with a chamfered surface or round honing having a width of 1 µm or less, the cutting edge having projections and depressions having a width of 100 nm or less.

The single-crystal diamond cutting tool configured as described above has an inclined surface inclined at 0.05 degrees or more and 80 degrees or less with respect to the rake face and can thus have the rake face with roughness Ra of 1 µm or less. If the inclined surface has an inclination of less than 0.01 degrees, the inclination is too small and it is difficult to polish the rake face. If the inclined surface has an inclination exceeding 80 degrees, and the rake face is polished, the boundary between the inclined surface and the rake face will have a large roughness, and the rake face cannot have surface roughness of 1 µm or less.

Preferably, the rake face forms an angle of 0 degrees or more and 15 degrees or less with respect to a (110) plane. Within this range, the single-crystal diamond cutting tool has a particularly increased service life.

Preferably, the inclined surface has roughness Ra of 5 µm or less. When the inclined surface has a roughness of 5 µm or less, the rake face contiguous to the inclined surface will have small roughness, and the single-crystal diamond cutting tool has a long service life.

Preferably, the single-crystal diamond cutting tool provides a relief angle of 0 degrees or more and 30 degrees or less. Within this range, the single-crystal diamond cutting tool has a particularly long service life as the cutting tool can maintain the cutting edge’s strength while preventing the flank from coming into contact with a workpiece.

### First Embodiment

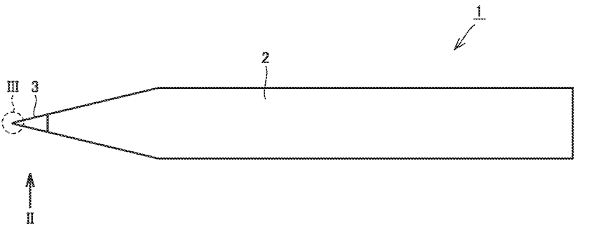

FIG. 1 is a plan view of a single-crystal diamond cutting tool 1 according to a first embodiment. As shown in FIG. 1, single-crystal diamond cutting tool 1 has a shank 2 and a single-crystal diamond 3 attached to the tip of shank 2. Shank 2 extends longitudinally. Shank 2 is made for example of cemented carbide.

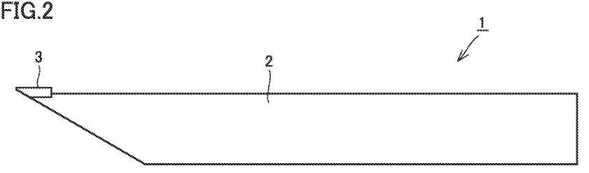

FIG. 2 is a side view of single-crystal diamond cutting tool 1 viewed in a direction indicated in FIG. 1 by an arrow II. As shown in FIG. 2, single-crystal diamond 3 is fixed to an upper surface of shank 2. Single-crystal diamond 3 and shank 2 are for example brazed together. Shank 2 has the tip pointed. This can prevent the tip of shank 2 from coming into contact with a workpiece.

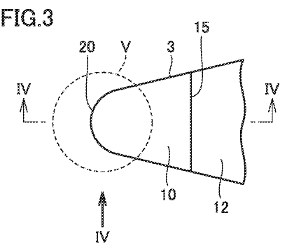

FIG. 3 is an enlarged plan view of a single-crystal diamond 3 of a portion surrounded by a circle III indicated in FIG. 1. As shown in FIG. 3, single-crystal diamond 3 is provided with a rake face 10. Rake face 10 is located at a tip portion of an upper surface of single-crystal diamond 3. Single-crystal diamond 3 is provided with an inclined surface 12 contiguous to rake face 10. A boundary 15 is located between rake face 10 and inclined surface 12.

Rake face 10 has a roughness Ra of 1 µm or less. Roughness Ra of rake face 10 can be measured for example with a white light interferometer. When rake face 10 has roughness Ra exceeding 10 µm, a rough processed surface is provided, resulting in a reduced tool service life.

Rake face 10 is not particularly limited in plane orientation. Rake face 10 preferably forms an angle of 0 degrees or more and 15 degrees or less with respect to a (110) plane of single-crystal diamond 3. The most distal end portion of rake face 10 is a cutting edge 20. Cutting edge 20 has an arcuate shape in FIG. 3. Cutting edge 20 is a portion which comes into contact with a workpiece.

Inclined surface 12 preferably has roughness Ra of 5 µm or less. When inclined surface 12 has a roughness of 5 µm or less, rake face 10 contiguous to inclined surface 12 will have small roughness, and single-crystal diamond cutting tool 1 will have a particularly long service life. Roughness Ra of rake face 10 can be measured for example with a white light interferometer.

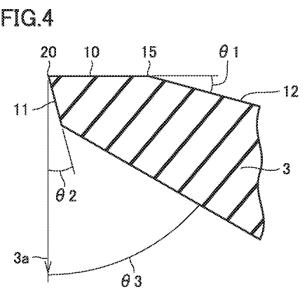

FIG. 4 is a cross section of single-crystal diamond 3 taken along a line IV-IV indicated in FIG. 3. As shown in FIG. 4, cutting edge 20 of single-crystal diamond 3 is located at a boundary portion between rake face 10 and flank 11. Inclined surface 12 has an angle θ1 (an inclination angle) with respect to rake face 10. Inclination angle θ1 is 0.01 degrees or more and 80 degrees or less. If inclination angle θ1 is less than 0.01 degrees, inclined surface 12 will be substantially flush with rake face 10, and inclined surface 12 will be an obstacle to polishing rake face 10 and rake face 10 cannot be polished sufficiently. If inclination angle θ1 exceeds 80 degrees, inclination angle θ1 is excessively large, resulting in large surface roughness in a vicinity of boundary 15. As a result, rake face 10 also has large surface roughness. Preferably, angle θ1 is 1 degree or more and 50 degrees or less, more preferably 10 degrees or more and 30 degrees or less.

Flank 11 has an angle θ2 (a relief angle) with respect to a direction in which a workpiece is moved, as indicated by an arrow 3a. Angle θ2 is not particularly limited. Relief angle θ2 can be measured with a projector.

Preferably, angle θ2 is 5 degrees or more and 25 degrees or less, more preferably 10 degrees or more and 20 degrees or less. Single-crystal diamond 3 has a lower surface with an angle θ3 with respect to the direction in which a workpiece is moved, as indicated by arrow 3a. Angle θ3 is not particularly limited.

Inclination angle θ1 can be measured with a white light interferometer. Relief angle θ2 and angle θ3 can be measured with a projector.

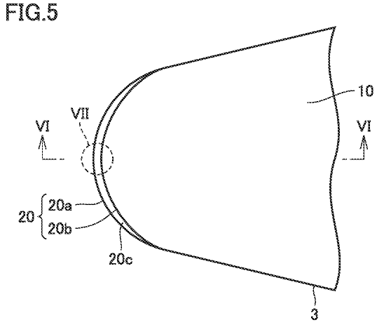

FIG. 5 is an enlarged plan view of single-crystal diamond 3 of a portion surrounded by a circle V indicated in FIG. 3. As shown in FIG. 5, cutting edge 20 provided at an end of rake face 10 has a first cutting edge 20a and a second cutting edge 20b. First cutting edge 20a is provided outside, and second cutting edge 20b is provided inside. A portion between first cutting edge 20a and second cutting edge 20b is a chamfered surface 20c.

Chamfered surface 20c is formed by chamfering. Chamfered surface 20c is formed in an arcuate shape between first cutting edge 20a and second cutting edge 20b. Cutting edge 20 and chamfered surface 20c formed in an arcuate shape allow predetermined cutting performance to be exhibited even if a portion of cutting edge 20 coming into contact with a workpiece varies.

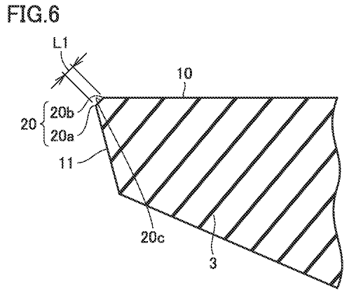

FIG. 6 is a cross section of single-crystal diamond 3 taken along a line VI-VI indicated in FIG. 5. As shown in FIG. 6, second cutting edge 20b is provided on a side closer to rake face 10. First cutting edge 20a is provided on a side closer to flank 11. Chamfered surface 20c has a width L1 of 1 µm or less. If chamfered surface 20c has width L1 exceeding 1 µm, chamfered surface 20c will have a shape which appears to be worn, resulting in a reduced service life.

Chamfered surface 20c has the width in the FIG. 6 cross section taken longitudinally of single-crystal diamond 3. Chamfered surface 20c preferably has width L1 of 50 nm or more and 400 nm or less. Width L1 of chamfered surface 20c can be measured for example with a 3D-scanning electron microscope (3D-SEM). The 3D-SEM can for example be ERA-600FE BSE manufactured by ELIONIX INC.

When cutting edge 20 is not arcuate and is for example instead square and the first cutting edge and the second cutting edge meet at the tip end, the chamfered surface’s width is defined by an average value in width of the chamfered surface in a cross section taken through the center of each of the first and second cutting edges and perpendicular to a direction in which the first and second cutting edges extend.

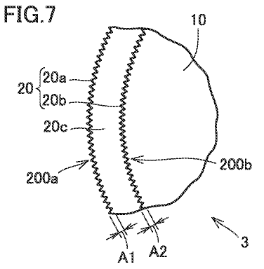

FIG. 7 shows projections and depressions 200a and 200b of first cutting edge 20a and second cutting edge 20b. As shown in FIG. 7, first cutting edge 20a is provided with projections and depressions 200a. Second cutting edge 20b is provided with projections and depressions 200b. Projections and depressions 200a and 200b have widths A1 and A2, respectively, of 100 nm or less and smaller than width L1 of chamfered surface 20c. If projections and depressions 200a and 200b have widths A1 and A2 exceeding 100 nm, a rough processed surface is provided resulting in reduced tool service life. Widths A1 and A2 of projections and depressions 200a and 200b can be measured for example with a 3D-SEM.

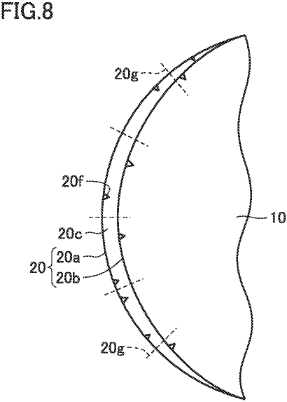

FIG. 8 is a diagram for illustrating a method of measuring width L1 of chamfered surface 20c. Width L1 of chamfered surface 20c is measured through the following procedure:

(1) A 3D-SEM set in 2D is used to observe cutting edge 20 in a direction perpendicular to rake face 10, as shown in FIG. 8, to randomly select ten points free of large chipping 20f. A portion indicated by a dotted line 20g is selected.

(2) Subsequently, a cross section of cutting edge 20 is obtained through the 3D-SEM at the location of dotted line 20g selected in step (1). It should be noted that this cross section indicates positional information of a surface of cutting edge 20, rake face 10 and flank 11, and does not include internal information of cutting edge 20. Chamfered surface 20c is imaged while the cross section is observed with the 3D-SEM.

(3) Subsequently, width L1 of chamfered surface 20c of each cross section is measured based on an image obtained in step (2).

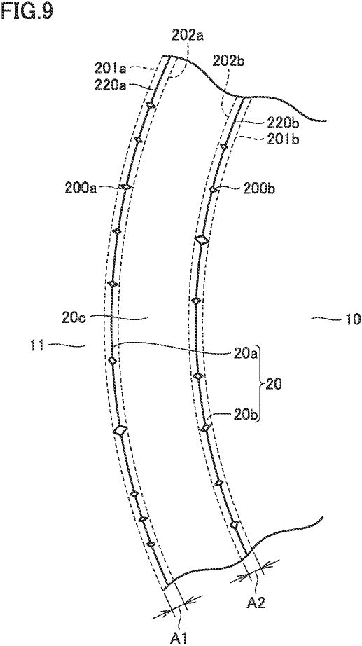

(4) Subsequently, an average value of 10 points measured in step (3) is defined as width L1 of the chamfered surface. FIG. 9 is a diagram for illustrating a method of measuring widths A1 and A2 of projections and depressions 20a and 20b of first cutting edge 20a and second cutting edge 20b. Widths A1 and A2 of projections and depressions 20a and 20b are measured through the following procedure:

(1) A 3D-SEM is used to image the cutting edge, as observed on the side of the tip of the cutting edge in a direction forming 45° with respect to rake face 10 and forming 45° with a direction perpendicular to rake face 10.

(2) A ridge line 220a of a portion of the boundary between flank 11 and chamfered surface 20c with no projections/depressions 200a observed serves as a reference. A curve 201a passing by an outermost projection of projections and depressions 200a and parallel to ridge line 220a is determined. A curve 202a parallel to ridge line 220a and passing by an innermost depression of projections and depressions 200a is drawn. The distance between the two curves 201a and 202a serves as a width of projections and depressions 200a. A ridge line 220b of a portion of the boundary between rake face 10 and chamfered surface 20c with no projections/depressions 200b observed serves as a reference. A curve 202b passing by an outermost projection of projections and depressions 200b and parallel to ridge line 220b is determined. A curve 201b parallel to ridge line 220b and passing by an innermost depression of projections and depressions 200b is drawn. The distance between the two curves 201b and 202b serves as a width of projections and depressions 200b.

(3) Measurement can be done in the above method as what has projections and depressions with a width of 10 nm or more can have the projections and depressions observed through a 3D-SEM. Projections and depressions having a width of less than 10 nm are unobservable. Therefore, it is determined that a size which is not observed as projections/depressions is less than 10 nm.

(4) The width of the projections and depressions is defined as an average value of both A1 of the boundary between rake face 10 and chamfered surface 20c and A2 of that between flank 11 and chamfered surface 20c, i.e., (A1 + A2)/2. That is, A1 and A2 obtained through calculation have the same value, that is, A1 = A2 = (A1 + A2)/2.

### Second Embodiment

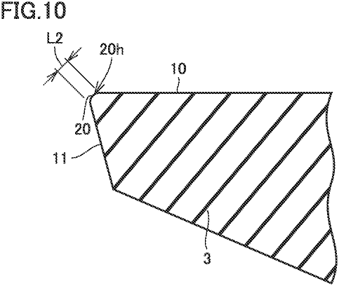

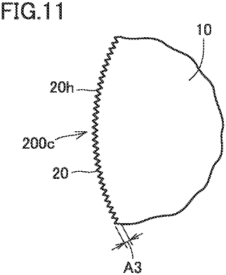

FIG. 10 is a cross section of single-crystal diamond 3 according to a second embodiment corresponding to FIG. 6, and is a cross section showing round honing 20h provided to cutting edge 20. FIG. 11 is an enlarged plan view of cutting edge 20 shown in FIG. 10.

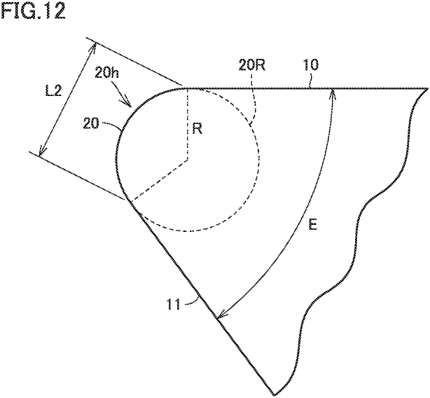

As shown in FIGS. 10 and 11, cutting edge 20 is formed by round honing 20h. Round honing 20h forming an arcuate shape in the FIG. 10 cross section orthogonal to cutting edge 20 is formed along cutting edge 20. Round honing 20h has width L2 of 1 µm or less. If round honing 20h has width L2 exceeding 1 µm, round honing 20h will have a shape which appears to be worn, resulting in a reduced service life. Round honing 20h preferably has width L2 of 50 nm or more and 400 nm or less. Width L2 of round honing 20h can be measured with a 3D-SEM through the following process: FIG. 12 is a cross section of a single-crystal diamond cutting tool having rake face 10 and flank 11 contiguous to round honing 20h, as taken orthogonally to rake face 10 and flank 11, for illustrating a method of measuring width L2 of round honing 20h. When round honing 20h is contiguous to rake face 10 and flank 11, width L2 of round honing 20h is measured through the following procedure:

(1) A 3D-SEM set in 2D is used to observe cutting edge 20 in a direction perpendicular to rake face 10 to randomly select ten points free of large chipping, similarly as done in the first embodiment.

(2) Subsequently, a cross section of cutting edge 20 is obtained through the 3D-SEM at each location selected in step (1). It should be noted that this cross section indicates positional information of a surface of cutting edge 20, rake face 10 and flank 11, and does not include internal information of cutting edge 20. Round honing 20h is imaged while the cross section is observed with the 3D-SEM.

(3) Subsequently, based on an image obtained in step (2), a circle 20R is formed at a portion overlapping round honing 20h, as shown in FIG. 12.

(4) Subsequently, a radius R of circle 20R obtained in step (3) is measured. (5) Subsequently, width L2 of round honing 20h is determined from radius R obtained in step (4), and a cutter angle E of rake face 10 and flank 11.

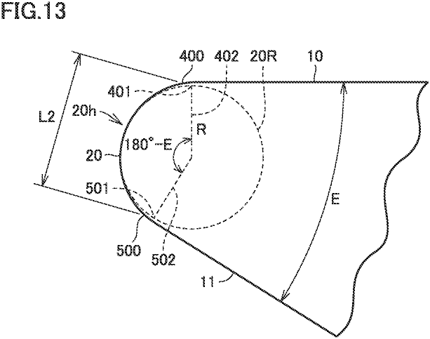

FIG. 13 is a cross section of a single-crystal diamond cutting tool having curved surfaces 400 and 500 between round honing 20h and rake face 10 and flank 11, as taken orthogonally to rake face 10 and flank 11, for illustrating a method of measuring width L2 of round honing 20h. For example, curved surfaces 400 and 500 having a radius larger than round honing 20h may be present adjacent to round honing 20h by polishing. In this case, width L2 of round honing 20h is measured through the following procedure:

(1) A 3D-SEM set in 2D is used to observe cutting edge 20 in a direction perpendicular to rake face 10 to randomly select ten points free of large chipping, similarly as done in the first embodiment.

(2) Subsequently, a cross section of cutting edge 20 is obtained through the 3D-SEM at each location selected in step (1). It should be noted that this cross section indicates positional information of a surface of cutting edge 20, rake face 10 and flank 11, and does not include internal information of cutting edge 20. Round honing 20h is imaged while the cross section is observed with the 3D-SEM.

(3) Subsequently, based on an image obtained in step (2), circle 20R is formed at a portion overlapping a tip portion of round honing 20h, as shown in FIG. 12.

(4) Subsequently, radius R of circle 20R obtained in step (3) is measured. A radius line 402 is drawn from the center of circle 20R toward the boundary portion between rake face 10 and curved surface 400 (such that radius line 402 and rake face 10 form an angle of 90°). An intersection point 401 between radius line 402 and circle 20R is determined. A radius line 502 is drawn from the center of circle 20R toward the boundary portion between flank 11 and curved surface 500 (such that radius line 502 and flank 11 form an angle of 90°). An intersection point 501 between radius line 502 and circle 20R is determined.

(5) Subsequently, from radius R obtained in step (4), and cutter angle E of rake face 10 and flank 11, the distance between intersection points 401 and 501, or width L2 of round honing 20h, is determined

Cutting edge 20 is provided with projections and depressions 200c. Projections and depressions 200c have a width A3 of 100 nm or less. Width A3 of projections and depressions 200c of round honing 20h can be measured with a 3D-SEM.

(1) A 3D-SEM is used to image the cutting edge, as observed on the side of the tip of the cutting edge in a direction forming 45° with respect to rake face 10 and forming 45° with a direction perpendicular to rake face 10.

(2) A ridge line of a portion of round honing 20h with no projections/depressions 200c observed serves as a reference. A first curve passing by an outermost projection of projections and depressions 200c and parallel to the ridge line is determined. A second curve parallel to the ridge line and passing by an innermost depression of projections and depressions 200c is drawn. The distance between the first and second curves serves as a width of projections and depressions 200c.

(3) Measurement can be done in the above method as what has projections and depressions with a width of 10 nm or more can have the projections and depressions observed through a 3D-SEM. Projections and depressions having a width of less than 10 nm are unobservable. Therefore, it is determined that a size which is not observed as projections/depressions is less than 10 nm.

### Example 1

Table 1

| table 1 sample nos | inclination angle θ1 | roughness Ra of rake face 10 | chamfered width L1 | width A1, A2 of projections & depressions of cutting edge | plane orientation of rake face | roughness Ra of inclined surface 12 | relief angle θ2 | No. of workpieces processed before iridescent surface appears (workpiece: φ5) |
|---|---|---|---|---|---|---|---|---|
| | deg | µm | µm | nm | | µm | deg | No. of workpieces |
| 1 | 5 | 0.5 | 0.5 | < 10 | (100) | 6 | 35 | 23 |
| 2 | 0.05 | 0.5 | 0.5 | < 10 | (100) | 6 | 35 | 20 |
| 3 | 80 | 0.5 | 0.5 | < 10 | (100) | 6 | 35 | 17 |
| 4 | 5 | 1 | 0.5 | 60 | (100) | 6 | 35 | 14 |
| 5 | 5 | 0.1 | 0.5 | < 10 | (100) | 6 | 35 | 21 |
| 6 | 5 | 0.5 | 1 | < 10 | (100) | 6 | 35 | 13 |
| 7 | 5 | 0.5 | 0.1 | < 10 | (100) | 6 | 35 | 21 |
| 8 | 5 | 0.5 | 0.5 | 95 | (100) | 6 | 35 | 12 |
| 9 | 5 | 0.5 | 0.5 | 50 | (100) | 6 | 35 | 16 |
| 10 | 100 | 2.4 | 0.5 | 320 | (100) | 6 | 35 | 1 |
| 11 | 0.01 | 1.5 | 0.5 | 190 | (100) | 6 | 35 | 1 |
| 12 | 5 | 1.2 | 0.5 | 130 | (100) | 6 | 35 | 3 |
| 13 | 5 | 2 | 0.5 | 250 | (100) | 6 | 35 | 1 |
| 14 | 5 | 0.5 | 2 | < 10 | (100) | 6 | 35 | 8 |
| 15 | 5 | 0.5 | 0.5 | 200 | (100) | 6 | 35 | 3 |

Table 2

| table 2 sample nos | inclination angle θ1 | roughness Ra of rake face 10 | chamfered width L1 | width A1, A2 of projections & depressions of cutting edge | plane orientation of rake face | roughness Ra of inclined surface 12 | relief angle θ2 | No. of workpieces processed before iridescent surface appears (workpiece: φ5) |
|---|---|---|---|---|---|---|---|---|
| | deg | µm | µm | nm | | µm | deg | No. of workpieces |
| 16 | 5 | 0.5 | 0.5 | < 10 | (110) | 6 | 35 | 30 |
| 17 | 5 | 0.5 | 0.5 | < 10 | (110) | 5 | 35 | 34 |
| 18 | 5 | 0.5 | 0.5 | < 10 | (110) | 2 | 35 | 38 |
| 19 | 5 | 0.5 | 0.5 | < 10 | (110) | 5 | 30 | 41 |
| 20 | 5 | 0.5 | 0.5 | < 10 | (110) | 5 | 20 | 44 |
| 21 | 5 | 0.5 | 0.5 | < 10 | (100) | 5 | 35 | 24 |
| 22 | 5 | 0.5 | 0.5 | < 10 | (100) | 2 | 35 | 26 |
| 23 | 5 | 0.5 | 0.5 | < 10 | (100) | 5 | 30 | 30 |
| 24 | 5 | 0.5 | 0.5 | < 10 | (100) | 5 | 20 | 33 |
| 25 | 5 | 0.5 | 0.5 | < 10 | (100) | 6 | 30 | 27 |
| 26 | 5 | 0.5 | 0.5 | < 10 | (100) | 6 | 20 | 29 |

Initially, there were prepared samples which were formed as shown in FIGS. 1 to 7, and had variously set inclination angle θ1, roughness Ra of rake face 10, width L1 of the chamfered surface, widths A1 and A2 of the projections and depressions of the cutting edge, the rake face’s orientation, roughness Ra of inclined surface 12, and relief angle θ2.

These samples were used to mirror-finish a mold for a lens (a workpiece: formed of a material which is a steel material plated with Ni-P). The mold has a cylindrical shape having a diameter φ of 5 mm with a tip having a spherical surface. It was determined that a tool in mirror-finishing the spherical surface reached its end of service life when an iridescent surface appeared on a finished surface.

The processing was done under the following conditions: Processing speed: 500 mm/sec at maximum (As the spherical surface is processed at a fixed rotational speed, the processing speed varies depending on the processed site.)
Coolant: oil mist
Cut depth: 1,000 µm
Feed: 1,000 µm/rev
Each tool’s service life was evaluated from how many workpieces (or lens molds) were processed before the tool reached its end of service life. As the processing proceeds, the cutting edge has increased surface roughness, and accordingly, the workpiece’s processed surface also has increased surface roughness. When the processed surface has surface roughness of a prescribed value or more, an iridescent surface appears due to reflection of light. It was determined that a tool passed when it successfully processed 12 workpieces. Sample Nos. 10 to 15 have been found to have short service life as they had an iridescent surface appearing before they successfully processed 12 workpieces.

Sample Nos. 16 to 20 having rake face 10 with a plane orientation of (110) have a longer service life than a sample having rake face 10 with a plane orientation of (100). This is because a crystal orientation with high abrasion resistance is located at the cutting edge.

Samples Nos. 17 to 24 having inclined surface 12 with surface roughness Ra of 5 µm or less have a longer service life than a sample having inclined surface 12 with surface roughness Ra exceeding 5 µm. This is because when inclined surface 12 is rough, rake face 10 will be rough, and the cutting edge will have large projections and depressions.

Sample Nos. 19, 20, and 23 to 26 having relief angle θ2 of 30 degrees or less have a longer service life than a sample having relief angle θ2 exceeding 30 degrees. This is because falling within this range allows the cutting edge to maintain strength while avoiding contact between the flank and the workpiece.

### Example 2

Table 3

| table 3 sample nos | inclination angle θ1 | roughness Ra of rake face 10 | width L2 of round honing | width A3 of projections & depressions of cutting edge | plane orientation of rake face | roughness Ra of inclined surface 12 | relief angle θ2 | No. of workpieces processed before iridescent surface appears (workpiece: φ5) |
|---|---|---|---|---|---|---|---|---|
| | deg | µm | µm | nm | | µm | deg | No. of workpieces |
| 101 | 5 | 0.5 | 0.5 | < 10 | (100) | 6 | 35 | 22 |
| 102 | 0.05 | 0.5 | 0.5 | < 10 | (100) | 6 | 35 | 20 |
| 103 | 80 | 0.5 | 0.5 | < 10 | (100) | 6 | 35 | 18 |
| 104 | 5 | 1 | 0.5 | 55 | (100) | 6 | 35 | 15 |
| 105 | 5 | 0.1 | 0.5 | < 10 | (100) | 6 | 35 | 19 |
| 106 | 5 | 0.5 | 1 | < 10 | (100) | 6 | 35 | 14 |
| 107 | 5 | 0.5 | 0.1 | < 10 | (100) | 6 | 35 | 23 |
| 108 | 5 | 0.5 | 0.5 | 95 | (100) | 6 | 35 | 13 |
| 109 | 5 | 0.5 | 0.5 | 50 | (100) | 6 | 35 | 16 |
| 110 | 100 | 2.3 | 0.5 | 340 | (100) | 6 | 35 | 1 |
| 111 | 0.01 | 1.5 | 0.5 | 200 | (100) | 6 | 35 | 1 |
| 112 | 5 | 1.2 | 0.5 | 130 | (100) | 6 | 35 | 2 |
| 113 | 5 | 2 | 0.5 | 230 | (100) | 6 | 35 | 1 |
| 114 | 5 | 0.5 | 2 | < 10 | (100) | 6 | 35 | 6 |
| 115 | 5 | 0.5 | 0.5 | 200 | (100) | 6 | 35 | 3 |

There were prepared samples which were formed as shown in FIGS. 8 and 9, and had variously set inclination angle θ1, roughness Ra of rake face 10, width L2 of the round honing, width A3 of the projections and depressions of the cutting edge, roughness Ra of inclined surface 12, and relief angle θ2.

These samples were used to mirror-finish a mold for a lens (a workpiece: formed of a material which is a steel material plated with Ni-P). The mold has a cylindrical shape having a diameter φ of 5 mm with a tip having a spherical surface. It was determined that a tool in mirror-finishing the spherical surface reached its end of service life when an iridescent surface appeared on a finished surface.

The processing was done under the following conditions: Processing speed: 500 mm/sec at maximum (As the spherical surface is processed at a fixed rotational speed, the processing speed varies depending on the processed site.)
Coolant: oil mist
Cut depth: 1,000 µm
Feed: 1,000 µm/rev
Each tool’s service life was evaluated from how many workpieces (or lens molds) were processed before the tool reached its end of service life. As the processing proceeds, the cutting edge has increased surface roughness, and accordingly, the workpiece’s processed surface also has increased surface roughness. When the processed surface has surface roughness of a prescribed value or more, an iridescent surface appears due to reflection of light. It was determined that a tool passed when it successfully processed 12 workpieces. Sample Nos. 110 to 115 have been found to have short service life as they had an iridescent surface appearing before they successfully processed 12 workpieces.

It should be understood that the embodiments and examples disclosed herein are illustrative and not restrictive in all respects. The scope of the present invention is indicated by the appended claims rather than by the embodiments described above, and is intended to include all modifications within the scope and meaning equivalent to the claims.

### Industrial Applicability

The present disclosure is applicable in the field of single-crystal diamond cutting tools.

### Reference Signs List

1 single-crystal diamond cutting tool, 2 shank, 3 single-crystal diamond, 10 rake face, 11 flank, 12 inclined surface, 15 boundary, 20 cutting edge, 20a first cutting edge, 20b second cutting edge, 20c chamfered surface, 20h round honing, 200a, 200b, 200c projections and depressions

1. A single-crystal diamond cutting tool provided with a flank and a rake face,
a cutting edge being provided at a boundary between the flank and the rake face,
an inclined surface being provided at a location distant from the cutting edge, the inclined surface being contiguous to the rake face and inclined at 0.05 degrees or more and 80 degrees or less with respect to the rake face,
the rake face having a roughness Ra of 1 µm or less,
the cutting edge being provided with a chamfered surface or round honing having a width of 1 µm or less,
the cutting edge having projections and depressions having a width of 100 nm or less and smaller than that of the chamfered surface or round honing.

2. The single-crystal diamond cutting tool according to claim 1, wherein the rake face forms an angle of 0 degrees or more and 15 degrees or less with respect to a (110) plane.

3. The single-crystal diamond cutting tool according to claim 1 , wherein the inclined surface has a roughness Ra of 5 µm or less.

4. The single-crystal diamond cutting tool according to claim 1, providing a relief angle of 0 degrees or more and 30 degrees or less.
